(19) United States
(12) Patent Application Publication
(10) Pub. No.: US 2010/0314889 A1
(43) Pub. Date: Dec. 16, 2010

(54) LATCH ASSEMBLY

(75) Inventors: Ya-Hsiung Wang, Taoyuan (TW); Chi-Meng Phang, Taoyuan (TW)

Correspondence Address: ROGER H. CHU, 19499 ERIC DRIVE, SARATOGA, CA, 95070, US

(73) Assignee: SOLTEAM ELECTRONICS, CO., LTD., Taoyuan (TW)

(21) Appl. No.: 12/484,373

(22) Filed: Jun. 15, 2009

(51) Int. Cl. E05C 19/10

(52) U.S. Cl. 292/97

(57) ABSTRACT

A latch assembly includes a body having an accommodating space, two pairs of retaining recesses, a window, and a resilient element; a carrier received in the accommodating space and having one end pivotally connected to the body and an opposite end abutting against the resilient element; a driven member received in the accommodating space and abutting against the carrier, the driven member including a main shaft, a guide post, and a notched portion corresponding in position to the window of the body; and a driving member having a connecting portion to be inserted into the window and coupled with the notched portion of the driven member so as to form a loose fit with the driven member. When the connecting portion is inserted into the window and coupled with the notched portion, the driven member is drawn by the driving member to move and rotate within the retaining recesses.

### BACKGROUND OF THE INVENTION

1. Technical Field

The present invention relates to latches and, more particularly, to a latch assembly that functions mainly on a driven member capable of rotation and translation and is characterized by a compact structure, simple components, and high stability.

2. Description of Related Art

By virtue of the industrial revolution and the advancement of technological civilization, housework which used to take a lot of time and energy to accomplish, such as clothes washing, dish cleaning, baking, and cooking, has now been taken care of or assisted by various household appliances like washing machines, clothes dryers, dish washers, ovens, and microwave ovens so that the chores are easily and efficiently done. In a sense, these household appliances have become necessaries to the modern life.

Although these household appliances operate upon different principles and provide different functions, they are actually similar in structure and use. More specifically, dirty clothes, used dishes, or frozen food are put into a processing space that is formed in the body of a household appliance and is kept closed by a door. Then, water, air, or microwave is delivered into the appliance for washing, cleaning, drying, thawing, or cooking purposes. Thus, closeness of the processing space is important for ensuring proper functions and performance of the appliance. On the other hand, a household appliance for daily use usually has its door frequently opened and closed. Therefore, in order to maximize the service life and efficiency of the household appliance, a competent and reliable door latch is essential.

Conventional door latches for household appliances are typically based on electromagnetic valves or spring-loaded buttons. Despite their advantageously easy and straightforward operation, these two types of latches are nevertheless disadvantaged by their complex structures and numerous components, which require complicated manufacturing processes and high production costs. Besides, as the aforesaid two types of conventional latches use a considerable number of metal components, their material costs are also high. Moreover, an electromagnetic valve tends to malfunction as the magnetic property of its components degrades due to long-term use. A spring-loaded button, on the other hand, is likely to become stuck or loose when its metal parts are rusted, thus having a very limited service life.

Hence, it has long been a goal of the industry to develop a latch assembly which not only maintains the advantages of the prior art devices, such as easy and straightforward operation, but also has a simple structure, low manufacturing costs, a long service life, and enhanced stability so as to overcome the disadvantages of the prior art devices.

### SUMMARY OF THE INVENTION

The main concept of the present invention is to use a driven member capable of both rotation and translation and develop therefrom, through proper mechanism design, a latch assembly that features compact structure, simple components, low costs, high stability, and applicability to doors based on various mechanisms.

One objective of the present invention is to provide a latch assembly whose components are easy to design and highly applicable. By using a common and popular mechanical design, coupling and decoupling between the components of the latch assembly are reliably achieved so that the latch assembly is enabled to function as a door latch for household appliances, thereby effectively remedying the drawbacks of the conventional devices, such as complicated structure, an excessively large number of components, elevated costs, and high wear and tear.

According to the present invention, a latch assembly includes a body, a carrier, a driven member, and a driving member. The body has an internal accommodating space, two pairs of retaining recesses, a window, and a resilient element. The two pairs of retaining recesses are formed respectively on two lateral walls of the body and include a pair of straight slots and a pair of L-shaped grooves. The window is formed at a bottom of the body near one end thereof while the resilient element is fixed to a bottom of the accommodating space.

The carrier is settled in the accommodating space of the body and has one end pivotally connected to the body and an opposite end abutting against the resilient element. Consequently, the carrier has a displacement path in the accommodating space that is defined by the resilient element.

The driven member is settled at an appropriate position in the accommodating space and abuts against the carrier while being carried thereby. The driven member includes a notched portion, a main shaft, and a guide post. The notched portion is formed at one end of the driven member and corresponds in position to the window of the body. When the driving member is inserted into the window and coupled with the notched portion, the driven member is drawn by the driving member so as to rotate and move within a limited angular range defined by the retaining recesses. The main shaft and the guide post pass through the driven member and abut against the corresponding retaining recesses of the body, respectively, so that the main shaft and the guide post are slidable in the corresponding retaining recesses.

The driving member, which is connected to and controlled by a control unit, has a connecting portion formed at one end of the driving member. The connecting portion is for being inserted into the window of the body and coupled with the notched portion of the driven member, so that the driving member forms a loose fit with the driven member.

When the driving member moves under the control of the control unit, the connecting portion of the driving member touches the notched portion of the driven member and thus applies a pushing force pushing the driven member to rotate. In consequence, the main shaft and the guide post move in the corresponding retaining recesses. When the main shaft and the driven shaft move to specific positions defined in and by the retaining recesses, the driven member stops rotating, and the driving member is completely coupled with the notched portion of the driven member so that the latch assembly enters a locked state. When the driving member moves reversely under the control of the control unit, the driving member is released from the driven member. When the driving member is completely released from the driven member, the latch assembly is turned from the locked state into an opened state.

### BRIEF DESCRIPTION OF THE DRAWINGS

The invention as well as a preferred mode of use, further objectives, and advantages will be best understood by reference to the following detailed description of an illustrative embodiment when read in conjunction with the accompanying drawings, wherein:

FIG. 1 is a top view of a latch assembly according to one preferred embodiment of the present invention;

FIG. 2 is an exploded perspective view of the latch assembly of FIG. 1; and

FIG. 3 and FIG. 4 are sectional views illustrating operation of the latch assembly of FIG. 1.

### DETAILED DESCRIPTION OF THE PREFERRED EMBODIMENTS

The present invention relates to a latch assembly that uses a simple mechanism design based on a driven member capable of rotation and translation so that the latch assembly features a compact structure, simple components, low costs, and high stability.

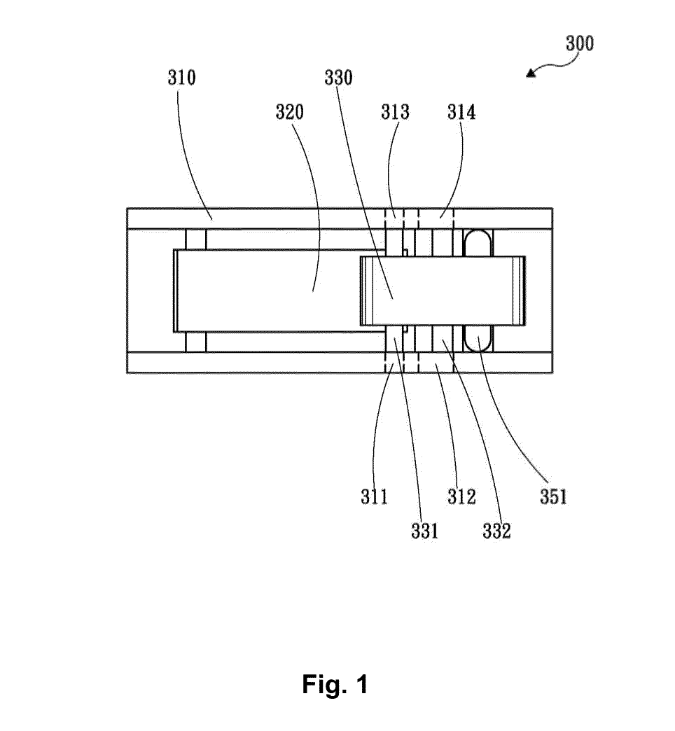

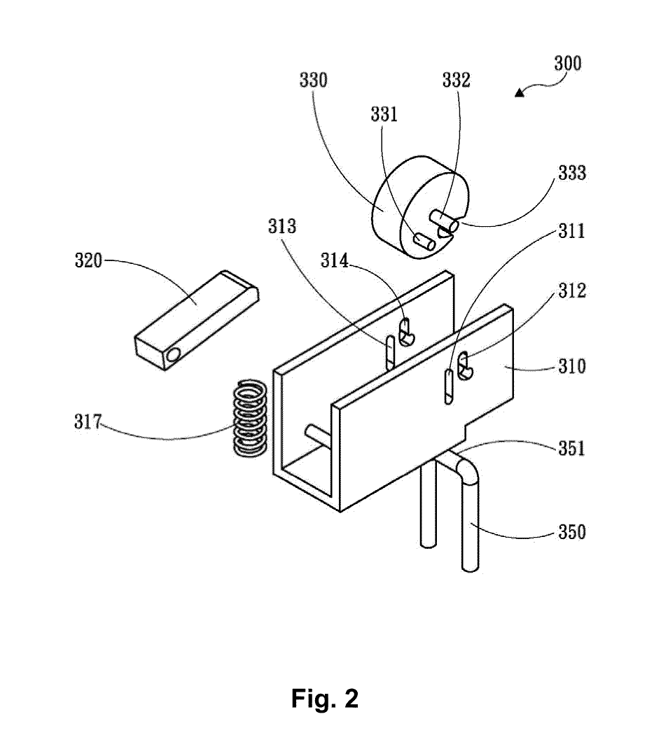

Please refer to FIGS. 1 and 2 for a top view and an exploded perspective view of a latch assembly 300 according to one preferred embodiment of the present invention. As shown in the drawings, the latch assembly 300 includes an L-shaped body 310, a carrier 320, a driven member 330, a locking tongue 350, and a resilient element 317. Therein, the L-shaped body 310 may be alternatively formed with an acute angle or an obtuse angle, instead of the right angle depicted in the drawings.

An accommodating space is defined inside the L-shaped body 310. Two pairs of retaining recesses are formed respectively on a first lateral wall and a second lateral wall of the L-shaped body 310 that are opposite to each other. The first retaining recess 311 and the second retaining recess 312 on the first lateral wall correspond in position to the third retaining recess 313 and the fourth retaining recess 314 on the second lateral wall, respectively. Therein, the first retaining recess 311 and the third retaining recess 313 are straight slots while the second retaining recess 312 and the fourth retaining recess 314 are L-shaped grooves.

The L-shaped body 310 additionally has a window 316 and receives the resilient element 317. The window 316 is formed at a bottom of the L-shaped body 310 near one end thereof while the resilient element 317 is fixed to a bottom of the accommodating space.

The carrier 320 is settled in the accommodating space of the L-shaped body 310 and has one end pivotally connected to the L-shaped body 310 and an opposite end abutting against the resilient element 317 so that the resilient element 317 defines a linear displacement path of the carrier 320 in the accommodating space.

The driven member 330 is settled in the accommodating space of the L-shaped body 310 and abuts against the carrier 320 while being carried thereby. The driven member 330 further includes a guide post 331, a main shaft 332, and a notched portion 333. The guide post 331 and the main shaft 332 are rigid members with arbitrary cross sectional shapes, such as a round shape, an oval shape, a water-drop shape, or any other applicable shape. Moreover, the guide post 331 and the main shaft 332 are separated by a consistent distance. The guide post 331 and the main shaft 332 may be integrally formed with or assembled to the driven member 330 having the notched portion 333. The guide post 331 and the main shaft 332 pass through the driven member 330 and jut out of two lateral walls of the driven member 330 so as to be received in and abut against the retaining recesses 311, 312, 313, and 314 of the L-shaped body 310, respectively. Therein, two ends of the guide post 331 abut against the first and third retaining recesses 311 and 313, respectively, while two ends of the main shaft 332 abut against the second and fourth retaining recesses 312 and 314, respectively. Thus, the guide post 331 and the main shaft 332 are retained by the retaining recesses 311, 312, 313, and 314 and are only allowed to slide therein. The notched portion 333 is formed at one end of the driven member 330 and corresponds in position to the window 316 of the L-shaped body 310.

The locking tongue 350 is connected to and controlled by a control unit (not shown). The locking tongue 350 has one end formed as a hitch portion 351 corresponding in position to the window 316 of the L-shaped body 310 so that the hitch portion 351 can be inserted into the window 316 and coupled with the notched portion 333 of the driven member 330, thereby forming a loose fit with the driven member 330.

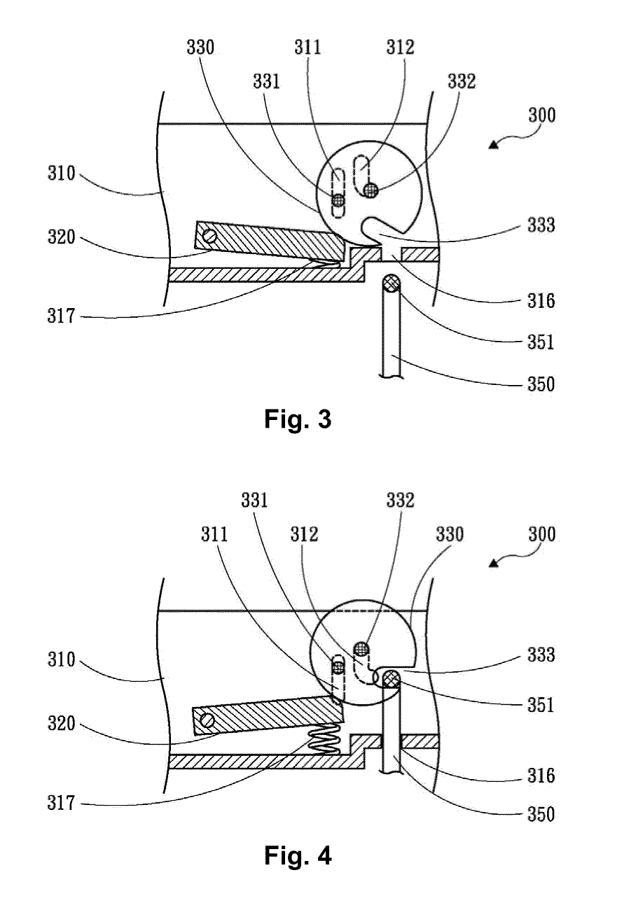

FIG. 3 and FIG. 4 illustrate operation of the latch assembly 300. As shown in the drawings, when the locking tongue 350 moves forward under the control of the control unit (not shown), the hitch portion 351 of the locking tongue 350 enters the window 316 of the L-shaped body 310 and touches the notched portion 333 of the driven member 330. Thus, the locking tongue 350 exerts a pushing force that pushes the driven member 330 to rotate. As a result, the main shaft 332 moves in and along the corresponding second and fourth retaining recesses 312 and 314 of the L-shaped body 310. As the guide post 331 and the main shaft 332 are separated by the consistent distance and are both rigid members, the guide post 331 is driven to move in and along the straight first and third retaining recesses 311 and 313. Meantime, rotation of the driven member 330 changes the initial static equilibrium of the driven member 330 against the carrier 320 so that the carrier 320 propped by the resilient element 317 applies another pushing force to the driven member 330, thereby speeding up the rotation of the driven member 330 as well as translation of the guide post 331 and the main shaft 332 in the retaining recesses 311, 312, 313, and 314. At this time, the notched portion 333 of the driven member 330 applies a pulling force to draw the hitch portion 351 of the locking tongue 350 into the notched portion 333, and in consequence the hitch portion 351 abuts against an inner edge of the notched portion 333. Finally, when the guide post 331 and the main shaft 332 arrive at their limits in the retaining recesses 311, 312, 313, and 314, the driven member 330 stops rotating, and the carrier 320 also stops moving so that the latch assembly 300 reaches a new static equilibrium. Now, with the hitch portion 351 of the locking tongue 350 completely coupled with the notched portion 333 of the driven member 330, the latch assembly 300 is in a locked state.

When the locking tongue 350 moves reversely under the control of the control unit, the locking tongue 350 pulls the driven member 330 to move, and consequently the hitch portion 351 of the locking tongue 350 begins to disengage from the notched portion 333 of the driven member 330. The driven member 330 applies a pressure to the carrier 320 as the guide post 331 and the main shaft 332 move reversely. When the guide post 331 and the main shaft 332 finally reach their opposite limits in the retaining recesses 311, 312, 313, and 314, the guide post 331 and the main shaft 332 stop moving. At this time, the locking tongue 350 is completely released from the driven member 330, and the latch assembly 300 is turned from the locked state into an opened state where a new static equilibrium is achieved.

While the present invention is herein described by reference to the preferred embodiment, it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A latch assembly, comprising:
a body defining therein an accommodating space and comprising:
at least two pairs of retaining recesses formed respectively on a first lateral wall and a second lateral wall of the body that are opposite to each other, wherein a first retaining recess and a second retaining recess on the first lateral wall correspond in position to a third retaining recess and a fourth retaining recess on the second lateral wall, respectively;
a window formed at a bottom of an end of the body; and
a resilient element fixed to a bottom of the accommodating space;
a carrier axially settled in the accommodating space of the body and having an end pivotally connected to the body and an opposite end abutting against the resilient element so that the carrier has a linear displacement path in the accommodating space that is defined by the resilient element;
a driven member settled at an appropriate position in the accommodating space of the body and abutting against the carrier while being carried by the carrier, the driven member comprising:
a notched portion formed at an end of the driven member and corresponding in position to the window of the body, the driven member being drawn by the driving member so as to move and rotate within a limited angular range defined by the retaining recesses when a driving member is coupled with the notched portion through the window; and
at least a main shaft and at least a guide post which pass through the driven member and abut against the retaining recesses of the body, respectively, so that the main shaft and the guide post have displacement paths defined by the corresponding retaining recesses, the main shaft and the guide post being separated by a consistent distance, wherein two ends of the guide post abut against the first retaining recess and the third retaining recess, respectively, and two ends of the main shaft abut against the second retaining recess and the fourth retaining recess, respectively; and
the driving member connected to and controlled by a control unit and having a connecting portion that is formed at an end of the driving member and is configured for being inserted through the window of the body and female-connected with the notched portion of the driven member so as to form a loose fit with the driven member;
wherein when the driving member moves under control of the control unit, the connecting portion of the driving member touching the notched portion of the driven member so as to apply a pushing force to the driven member for rotation, so that the main shaft moves in the corresponding retaining recesses, and since the main shaft and the guide post being separated by the consistent distance, the guide post being also driven to move; and when the guide post moves to a specific position defined in and by the corresponding retaining recesses, the driven member stopping rotation, and the connecting portion of the driving member being completely female-connected with the notched portion of the driven member so that the latch assembly enters a locked state when the driving member moves reversely under the control of the control unit, the driving member being released from the driven member; and when the driving member is completely released from the driven member, the latch assembly entering an opened state.

2. The latch assembly of claim 1, wherein the body is a housing, which shape is selected from the group consisted of: L-shape, L-shape with an acute angle, and L-shape with an obtuse angle.

3. The latch assembly of claim 1, wherein the first retaining recess and the third retaining recess are straight slots while the second retaining recess and the fourth retaining recess are L-shaped grooves.

4. The latch assembly of claim 1, wherein the guide post of the driven member are rigid members.

5. The latch assembly of claim 1, wherein the driving member is a locking tongue.

6. The latch assembly of claim 1, wherein the connecting portion of the driving member is a hitch portion.
